(19) United States
(12) Patent Application Publication
(10) Pub. No.: US 2012/0195999 A1
(43) Pub. Date: Aug. 2, 2012

(54) DRINK COMPOSITION

(75) Inventors: Harri Hakkarainen, Hollola (FI); Tea Skinnari, Lahti (FI)

(73) Assignee: NORTHFORCE OY, Oulu (FI)

(21) Appl. No.: 13/366,021

(22) Filed: Feb. 3, 2012

Related U.S. Application Data
(63) Continuation-in-part of application No. PCT/FI2009/050645, filed on Aug. 4, 2009.

(51) Int. Cl. A23L 2/38; A23J 1/20; A23L 2/68; A23L 2/39; A23L 2/66; A23L 1/304; A23L 2/385

(52) U.S. Cl. 426/2; 426/590; 426/74

(57) ABSTRACT

The present invention provides a drink composition for maintaining and/or restoring the fluid balance, for example during a sports event or an exercise containing proteins, carbohydrates and salts. The present invention also provides the use of said drink composition for maintaining and/or restoring the fluid balance during a sports event or an exercise. The present invention also provides a method for treating or preventing dehydration.

### CROSS REFERENCE TO RELATED APPLICATION

This application is a continuation-in-part of International Application No. PCT/FI2009/050645 filed Aug. 4, 2009, the entire contents of all of which are incorporated by reference as if fully set forth.

### FIELD OF THE INVENTION

The present invention relates to a recovery drink composition. More particularly, the present invention relates to a recovery drink composition which maintains and restores the fluid balance of a person, such as an athlete during a sports event or an exercise.

### BACKGROUND OF THE INVENTION

In environments where the loss of fluids and salts is extremely high, such as hot/moist and/or high climate or windy and hot environment, said loss generally causes loss of performance for an athlete or even disorders of consciousness and increases the risk of e.g. arrhythmia. In such conditions the problem also is the decrease in the volume of blood fluid, i.e. the decrease in plasma volume. This is caused by the loss of blood to the surrounding tissues because salt is sweated out from the blood (exercise-associated hyponatremia). This risk is high especially in high-performance and long-lasting performances during which the intake and the absorption of fluid from the digestive track is disturbed. In such situation the fluid to be consumed should irritate the stomach and digestive track as little as possible and it should be able to prevent the drying of the body.

Generally sports drinks are used to balance this condition. One generally known example of such product is Gatorade®, which is described in GB 1252781, wherein the drink contains 21 meq/1 of sodium, 2 meq/1 of potassium and 6% of sucrose.

U.S. Pat. No. 4,042,684 describes a beverage for supplementing the dietetic requirements of sugar and essential salts in a mammalian body depletable through vigorous physical activity, whereby the level of available utilizable energy stores within the body are enhanced, comprising an aqueous solution of sugar, sodium chloride, potassium chloride, and free citric acid in precise compositional ranges.

However, normal sports drinks contain generally lots of fluid (water), quite a lot of sugar and small amounts of salts. The problem with such drinks is that the drink does not remain in the blood but the fluid “leaks” out from the plasma resulting in an increase in hemoglobin concentration. Also the concentration of urine will be increased. Therefore such sports drinks provide only a temporary help in maintaining the fluid balance of the body.

The products on the market do not serve exercisers' and athletes' physiological needs. Traditionally, the content of products was based on inadequate knowledge of the nature of sports, and too much on consumers' taste habits. For instance the good sugary taste and selling color were considered more essential than the physiological effects of the products.

It has been discovered in accurate and independent studies that small amounts of impurities or substances prohibited in competitive sports have been found in some of the nutritional supplements available on the market. Only very few manufacturers of nutritional supplements have been able to ensure the purity and origin of their products.

It has been difficult for athletes to find hydration and recovery products customized according to their own event, development stage and training season. Several athletes and active exercisers may have used the very same product all year around without considering the physiological needs of the body during different types of training seasons.

There is still need for more efficient recovery drinks which could maintain the fluid balance and therefore the performance of the athlete for a longer time.

### BRIEF DESCRIPTION OF THE INVENTION

In the present invention it was surprisingly discovered that when certain amounts of salts and proteins and only a minor amount of sugars were used in a sports drink, it could maintain the fluid balance for a prolonged time. This is likely caused by the amino acids contained in the proteins preventing the leakage of the fluid from the blood. Most likely the synergetic effect of proteins and salts together cause the increase and/or maintenance of the osmotic pressure thereby keeping the fluid in the plasma.

The drink composition may be used also for maintaining and/or restoring the fluid and/or electrolyte balance of a person in need thereof, such as an elderly or an unhealthy person. For example it is known that hospitalized elderly suffer from dehydration causing loss of fluids and drying of the body.

The present invention provides a drink composition for maintaining and/or restoring the fluid balance, for example during a sports event or an exercise, wherein the drink composition contains proteins in the range of 0.5-0.15% (w/v), carbohydrates in the range of 1.3-2.0% (w/v) and salts in the range of 0.08-0.12 (w/v). The present invention also provides said drink composition in dry form, such as a powder.

The present invention also provides use of said drink composition for maintaining and/or restoring the fluid balance of a person. The present invention also provides use of said drink composition for maintaining and/or restoring the fluid balance during a sports event or an exercise.

The present invention also provides a method for treating or preventing dehydration. “Dehydration” as used herein refers to any condition relating to loss of body fluids and/or electrolytes, drying of the body and/or disturbed fluid, carbohydrate and electrolyte balance of the body, as described herein.

One advantage of the present invention is that the fluid, carbohydrate and electrolyte balance of the body can be recovered and/or maintained for a long time during a sports event or an exercise.

Another advantage of the present invention is that the high concentration of urine can be avoided, for example during a sports event or an exercise.

Still another advantage of the present invention is that it maintains the endurance.

### BRIEF DESCRIPTION OF THE DRAWINGS

FIG. 1 shows the acute change in body weight during a 30 km high performance test run in a hot and high environment. Group 1 (n=5) consumed 100 cl of a traditional sports drink and Group 2 (n=5) consumed 100 cl of the drink composition of the invention.

FIG. 2 shows the acute change in the urine specific gravity during a 30 km high performance test run in a hot and high environment. Group 1 (n=5) consumed 100 cl of a traditional sports drink and Group 2 (n=5) consumed 100 cl of the drink composition of the invention.

FIG. 3 shows the daily change in body weight (BW) and the urine specific gravity (USG) for one runner during one week. The exercise was carried out in the same environment as the 30 km test run.

### DETAILED DESCRIPTION OF THE INVENTION

The present invention provides a drink composition for maintaining and/or restoring the fluid balance during a sports event or an exercise. Especially suitable sports or exercises are those which cause high loss of fluids and drying of the body. For example exercises carried out in a high climate or windy and hot environment or high-power or long-lasting exercises will cause such loss of fluids and therefore recovery or maintenance of the fluid balance is required. The drink may be consumed before, during or after the exercise.

The drink composition contains proteins, which help to keep the consumed fluid in the circulation. The protein concentration is in the range of 0.05-0.15% (w/v), preferably 0.07-0.13% (w/v). In one embodiment the protein concentration is about 0.1% (w/v). Any suitable protein may be used, but preferred are proteins having a good amino acid profile, such as whey proteins.

The drink composition also contains carbohydrates, which maintain the sugar balance of the blood and muscle glycogen. The carbohydrate concentration is in the range of 1.3-2.0% (w/v), preferably 1.45-1.55% (w/v). In one embodiment the carbohydrate concentration is about 1.5% (w/v). In one embodiment the carbohydrates are sugars. Monosaccharides are preferred, such as glucose and fructose, because of their fast effect. Also disaccharides, such as saccharose, may be added. In some cases also longer carbohydrates, such as glucose polymer maltodextrine, may be added in small amounts as support, for example 5-10%. Also combinations thereof may be used, but especially glucose is preferred. In one embodiment the glucose is provided as syrup. In any case, the sugar concentration should not exceed 3% because too concentrated sugar solution causes osmotic pressure which slows down the stomach functions.

The drink composition further contains salts, which will replace the salts lost during the exercise and maintain and recover the natural salt concentration. The salt concentration is in the range of 0.08-0.12% (w/v), preferably 0.09-0.11% (w/v). In one embodiment the salt concentration is about 0.1% (w/v). Suitable salts include sodium, potassium, such as sodium chloride or potassium chloride, and combinations thereof. Also other salts may be included, such as magnesium. Generally sodium is the most important salt especially to avoid hyponatremia.

In one embodiment the drink composition of the present invention contains substantially about 0.1% (w/v) of proteins, about 1.5% (w/v) of carbohydrates and about 0.1% (w/v) of salts. It is essential for the present invention that the concentrations do not vary too much from these values. The preferred ranges are optimal.

In another embodiment the drink composition of the present invention contains substantially about 0.1% (w/v) of whey proteins, about 1.5% (w/v) of sugars, preferably monosaccharides, such as glucose, and about 0.1% (w/v) of salts, such as sodium chloride and optionally potassium chloride.

It is essential that the osmolality of the drink composition is not too high causing the fluids to flow from the body into intestines. The drink composition should have osmolality of less than 300 mOsm/l, preferably less than 280 mOsm/l. Theoretically about 250 mOsm/l would be optimal.

The drink composition of the present invention may also contain other ingredients such as preservation agents, e.g. potassium sorbate or sodium benzoate. Also pH-adjusting agents may be included, such as bicarbonates and citrates. The citrates are preferred because in the body they are more potent buffering agents that bicarbonates. Suitable citrates include e.g. tripotassium citrate and magnesium citrate. In one embodiment the pH of the drink composition is about pH 4.0. In another embodiment the Brix of the drink composition is about 3.1. Also other suitable further ingredients may be included, such as antioxidants or flavoring agents.

In one embodiment the drink composition is provided in a form of a concentrate. In one embodiment the drink composition is provided in dry form, such as dried powder wherein only addition of water is required. The dry concentrate may be prepared e.g. by lyophilization and it has generally a longer shelf-life. Said composition may be in a single dosage package, either as a ready drink or as a concentrate, such as the dry form. Such dosages are useful especially in hospital environment or the like.

One embodiment of the present invention provides the use of said drink composition for maintaining and/or restoring the fluid balance during a sports event or an exercise.

One embodiment of the present invention provides a method for treating or preventing dehydration comprising administering said drink composition to a patient suffering from dehydration.

### EXAMPLES

### Example 1

The aim of the next study was to find out if the drink composition of the present invention can prevent drying of the body of international level long distance runners during a high power and long lasting run performance in a high and hot environment. Ten (10) runners (see Table 1), who had exercised before the study in Eldoret, Kenya at 2,000-2,200 m for at least one month, took part in the study.

TABLE 1
Background of the runners (n = 10)

| | | | record on half- |
|---|---|---|---|
| age | length (cm) | weight (kg) | marathon |
| 27.8 ± 6.1 | 181.0 ± 6.9 | 60.2 ± 5.5 | 63:20 ± 1:10 |

The runners performed a 30 km test run on a route starting from 2,100 m and ending at 2,200 m from the sea level. The run was started after a ten-minute warming-up at 11:00 when the temperature was 25° C. During the whole test run the sun was shining from a cloudless sky and the temperature rose about 2° C.

Immediately before and after the test run the runners were weighed and they gave a urine sample for determining the urine specific gravity. The runners were divided randomly into two groups. The first group (Group 1) consumed during the warming-up and the run 100 cl of a sports drink containing short-chain carbohydrates (4%). The second group (Group 2) consumed 100 cl of the drink composition of the invention containing 0.1% (w/v) of whey protein, 1.5% (w/v) of glucose and 0.1% (w/v) of sodium chloride.

The body weight of the runners was measured with a scale having an accuracy of ±100 g. The urine specific gravity was measured with a portable digital refraction meter wherein the most diluted (=water) urine specific gravity was 1.000.

The results were studied as means and standard deviation. The difference in the body weight and the urine specific gravity was tested with a two-way repeated measures variance analysis. P<0.05 was used as the level of statistical significance.

### Results

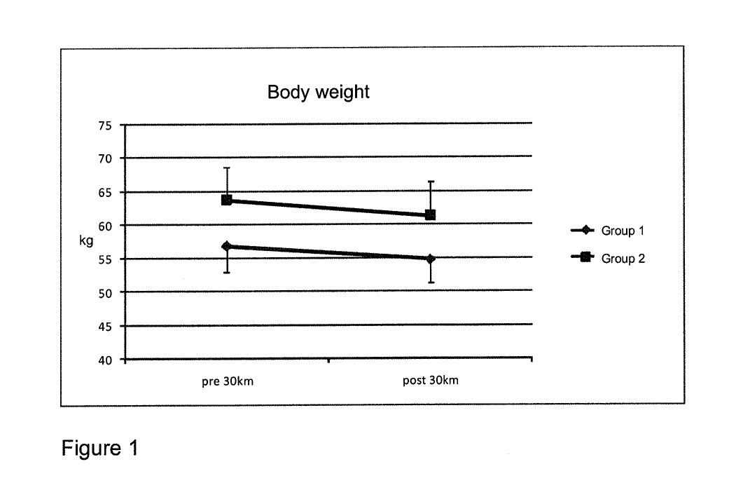

The runners of the both groups ran the 30 km test run in almost the same time. The time of the first group was 1:46:02±0:00:16 and the second group 1:46:08±0:00:16. During the run the body weight decreased a substantially equal amount for both groups: 3.5±0.6% for the first group and 3.7±0.7% for the second group (FIG. 1).

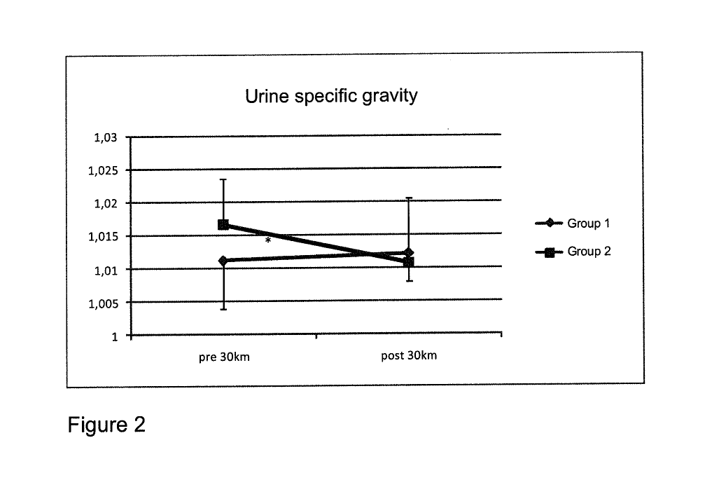

The urine specific gravity changed differently (P<0.05) between the two groups. In the first group the specific gravity increased with four runners (average 0.1±0.3%) but in the second group it decreased with all the runners (average 0.4±0.1%) (FIG. 2).

### Conclusions

The study demonstrated that the drink composition of the invention turned the urine into more dilute when compared to a traditional sports drink generally used in such long-distance performances in a demanding environment. When consuming the drink composition of the invention, none of the runners had their urine concentrated during the performance in spite of a high loss of fluids (over 3%). Low urine specific gravity is generally associated with good hydration condition.

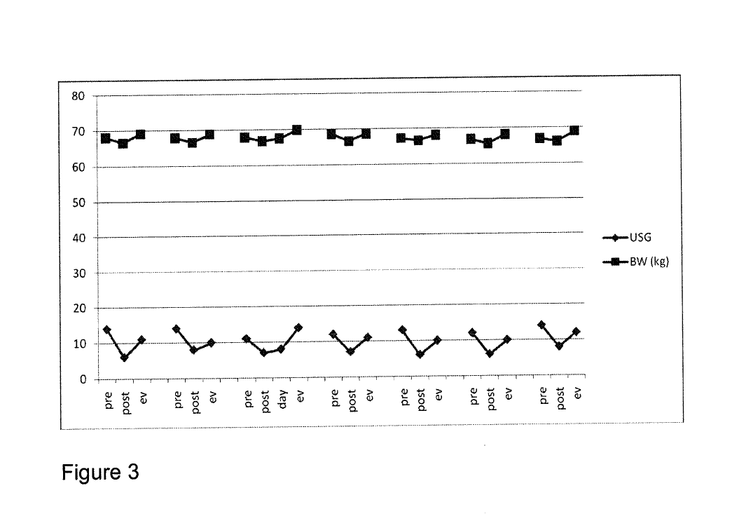

According to further follow-up monitoring of one runner, it seems that the urine specific gravity decreases systematically every day in spite of the loss of fluid and acute body weight (FIG. 3).

### Example 2

The drink composition was also evaluated in a thesis of Joona Prami and Marko Siltamies at Haaga-Helia University of Applied Sciences, Vierumaki Campus, Finland (2011). In the study the effect of the drink composition on the exertion of a long-term running was evaluated.

The aim of the study was to find out the effects of the consumption of Northforce Universal and Extreme (the drink composition of the invention) sports drinks on the heart rate during a long-term run, self-estimated exertion and subjective abdominal and muscle feelings.

### Methods

The target group consisted of 14 students from the Degree Programme in Sports and Leisure Management (Haaga-Helia University of Applied Sciences). The tests included three test runs. The test runs were executed weekly, three weeks in a row, with a speed corresponding to 75% of the maximal oxygen consumption. The length of the run was 20 km for male and 18 km for female subjects. All the runs were conducted on a 200 m indoor track at constant conditions. After each test run there was a 30-minute pause after which a further one kilometer run was run at the same speed as the long distance run. During the test runs conducted in mixed order one liter of Northforce Extreme (the drink composition of the invention), Northforce Universal (a carbohydrate-containing sports drink) or flavored water as a placebo/control were consumed. The heart rates and subjective experience of exertion (with Borg scale 6-20) were recorded from the test runs. Immediately after the test runs the runners evaluated the subjective abdominal and muscle feelings by 10 cm open scale.

### Results and Conclusions

The heart rate, subjective experience of exertion and abdominal and muscle feelings did not differ statistically between separate test runs. The fact that the exertion and the feelings were at the same level with all three drinks can be considered a promising finding for the drink of the invention which differs from a traditional sports drink in its composition. The abundant sodium content and the minor protein addition did not seem to cause any more nausea even with heavy exertion than water or a traditional sports drink having less of these ingredients. The sports drink of the invention seems to be able to maintain the salt balance and performance related to protein metabolism and further increase the effect of exercise in very hard and long-term exercises without any irritation of the stomach or digestive tract.

### Example 3

The drink composition was further evaluated in another thesis of Ville Altonen and Ismo Huotari at Haaga-Helia University of Applied Sciences, Vierumaki Campus, Finland (2011). In the study the effect of the drink composition to fluid balance in a long-term running was evaluated.

The aim of the study was to find out if the sports drink of the invention will maintain the fluid balance of the system in long-term exercise in a different way than any traditional sports drink or water.

### Methods

The target group consisted of 14 students from the Degree Programme in Sports and Leisure Management (Haaga-Helia University of Applied Sciences). The tests included three test runs. The test runs were executed weekly, three weeks in a row, with a speed corresponding to 75% of the maximal oxygen consumption. The length of the run was 20 km for male and 18 km for female subjects. All the runs were conducted on a 200 m indoor track at constant conditions. After each test run there was a 30-minute pause after which a further one kilometer run was run at the same speed as the long distance run. During the test runs conducted in mixed order one liter of Northforce Extreme (the drink composition of the invention), Northforce Universal (carbohydrate-containing sports drink) or flavored water as a placebo/control were consumed.

The test subjects were weighed and they gave urine and venal blood samples before each run, immediately after each run, and 30 minutes after each run. The specific weight of the urine was analyzed with a refractometer. Using this value and the change in the body weight the fluid state of the body was estimated. Hematocrite (the relative content of red blood cells analyzed from the venal blood sample) was used to depict the plasma volume.

### Results and Conclusions

The body weight decreased in different test runs approximately the same amount (1-1.5%) indicating that no harmful (over 2%) dehydration occurred in any of the test runs. Based on the change of the specific weight of urine the concentration of urine was low and the concentration did not differ statistically significantly between different runs. With both sport drinks the concentration of urine was suggestively lower than with water. Also the concentration of blood (decrease in the plasma volume) did not differ statistically significantly between different runs based on the changes in the hematocrite. The concentration of blood was the lowest with Northforce Extreme drink.

### Example 4

The drink composition was investigated in a study at University of Jyvaskyla, Finland (Stenholm, Mero, Vuorimaa, 2011). After run tests saliva, blood and urine samples were taken from the test subjects and analyzed for several factors, such as electrolytes, creatinine, albumin, immunogobulins etc. The studies confirmed that the drink composition helps maintaining the fluid balance and keeping the fluids in the plasma during an exercise.

Further embodiments herein may be described by reading any one of the below claims as depending on any two or more preceding claims in the alternative, or depending on any two or more preceding claims combined. A further embodiment may include describing any one of the claims below as depending from any two or more preceding claims, where the preceding claim(s) depends from any two or more preceding claims.

It will be appreciated that the methods of the present invention can be incorporated in the form of a variety of embodiments, only a few of which are disclosed herein. It will be apparent for a person skilled in the art that other embodiments exist and do not depart from the scope of the invention. Thus, the described embodiments are illustrative and should not be construed as restrictive.

What is claimed is:

1. A drink composition for one or more of maintaining or restoring the fluid balance, the drink composition comprising:
proteins in the range of 0.05-0.15% (w/v);
carbohydrates in the range of 1.3-2.0% (w/v); and
salts in the range of 0.08-0.12 (w/v).

2. The drink composition of claim 1, wherein the proteins are in the range of 0.07-0.13% (w/v).

3. The drink composition of claim 1, wherein the carbohydrates are in the range of 1.45-1.55% (w/v).

4. The drink composition of claim 1, wherein the salts are in the range of 0.09-0.11% (w/v).

5. The drink composition of claim 1, wherein the carbohydrates comprise sugars.

6. The drink composition of claim 5, wherein the sugars comprises glucose, fructose, saccharose or combinations thereof.

7. The drink composition of claim 1, wherein the salts comprise sodium, potassium or combinations thereof.

8. The drink composition of claim 1, wherein the proteins comprise whey proteins.

9. The drink composition of claim 1 comprising citrates.

10. The drink composition of claim 1, wherein the drink composition has on osmolality of less than 300 mOsm/l.

11. The drink composition of claim 10, wherein the osmolality is less than 280 mOsm/l.

12. The drink composition of claim 1, comprising:
about 0.1% (w/v) of proteins;
about 1.5% (w/v) of carbohydrates; and
about 0.1% (w/v) of salts.

13. The drink composition of claim 1, comprising:
about 0.1% (w/v) of whey proteins;
about 1.5% (w/v) of monosaccharides; and
about 0.1% (w/v) of salts.

14. The drink composition of claim 1 as a concentrate.

15. The drink composition of claim 13, wherein the concentrate is a dry powder.

16. A method of maintaining and/or restoring the fluid balance during a sports event or an exercise comprising administering the drink composition of claim 1.

17. A method for treating or preventing dehydration comprising administering the drink composition of claims 1 to a patient suffering from dehydration.
